(19) United States
(12) Patent Application Publication
(10) Pub. No.: US 2012/0298939 A1
(43) Pub. Date: Nov. 29, 2012

(54) Grain Silo Safety Apparatus

(76) Inventor: Jess Paul Andrews, Enid, OK (US)

(21) Appl. No.: 13/246,576

(22) Filed: Sep. 27, 2011

Related U.S. Application Data
(60) Provisional application No. 61/489,512, filed on May 24, 2011.

(51) Int. Cl. B66D 3/04; F16M 11/00

(52) U.S. Cl. 254/390; 248/127

(57) ABSTRACT

An apparatus for rescuing persons and objects from a grain storage bin or similar structures. The apparatus is made up of a bottom frame, a hoisting frame, and at least one rear bracing member. The hoisting frame has a top horizontal member with at least one attachment location supporting a safety mechanism and a plurality of legs attached to the top horizontal member. The plurality of legs are rotatably attached to the bottom frame. The apparatus has at least one rear bracing member rotatably attached to the bottom frame and securably attached to an anchoring feature.

### CROSS REFERENCE TO RELATED APPLICATION

This application claims the benefit of provisional patent application Ser. No. 61/489,512 filed on May 24, 2011, the entire contents of which are incorporated herein by reference.

### FIELD OF THE INVENTION

The present invention relates to the field of rescue apparatus, and more particularly to apparatus and a method for rescuing persons and objects from a grain storage bin or similar structure.

### SUMMARY OF THE INVENTION

The present invention comprises an apparatus for rescuing persons and objects from a grain storage bin or similar structure. The present invention comprises a bottom frame. The present invention also comprises a hoisting frame with a top horizontal member having at least one attachment location adapted to support a safety mechanism. The present invention has a plurality of legs. Each leg has a first end and a second end. The first ends of the plurality of legs are attachable to the top horizontal member, and the second ends of the plurality of legs are rotatably attached to the bottom frame. The present invention further comprises at least one rear bracing member with a first end and a second end. The first end of the bracing member is securable to an anchor, and the second end of the bracing member is rotatably attached to the bottom frame.

In another embodiment, the invention comprises a method for rescuing persons and objects from a grain storage bin having an access hatch. The method comprises the steps of lifting the safety apparatus to the roof of the grain storage bin. The safety apparatus comprises a bottom frame and a pulley assembly. The method comprises the further steps of assembling the bottom frame to circumscribe the access hatch, securing a first end of a security line to the pulley assembly, securing a second end of the security line to the grain storage bin, attaching the safety apparatus to a person or object to be rescued, operating the safety apparatus to extract the person or object to be rescued, and lowering the person or object safely to the ground. The second end of the security line alternately may be secured to a separate structure independent of the grain storage bin.

### BRIEF DESCRIPTION OF THE DRAWINGS

FIG. 1 is a perspective view of the invention installed on the top edge of a corrugated metal grain bin roof.

FIG. 2a is an illustration of structural features of a hoisting frame.

FIG. 2b is a detailed view of the hoisting frame with particular attention to security lines and safety apparatus.

FIG. 3 is a perspective view of the invention

FIG. 4a is a detailed view of a Z-shaped frame rail bracket.

FIG. 4b is a detailed view of a Z-shaped frame rail bracket assembly with tee-handled fasteners used to join a plurality of frame rails.

FIG. 5a is an exploded view of an L-shaped frame rail bracket and fasteners used to form a rotatable joint.

FIG. 5b is a detailed view of L-shaped frame rail brackets and tee-handled fasteners assembled to form a rotatable joint.

FIG. 6a is a detailed view of a frame rail assembly with chain and carabiner installed to provide additional security line connections.

FIG. 6b is a top view of a bottom frame assembly with anchor magnets installed.

FIG. 7a and FIG. 7b are detailed views of a bracket assembly used to attach anchor magnets to a bottom frame.

FIG. 8 is a top view showing a bottom frame with anchor magnets positioned with respect to the access hatch and the edge of the grain bin roof.

FIG. 9a and FIG. 9b are detailed views showing attachment hardware and assembly details for joining the rear brace to the hoisting frame legs.

FIG. 10 is a detailed view of the preferred embodiment's attachment of rear brace and hoisting frame legs.

FIG. 11 is a detailed view of tee-handled bolts and corresponding nuts for use with the bottom frame.

FIG. 12 is a detailed view of a wrench preferred for use with tee-handled bolts.

### BACKGROUND OF THE INVENTION

Fire protection and rescue services occasionally are called upon to rescue injured individuals in remote, difficult, or hazardous locations. One of the more difficult situations, very dangerous for the victim and rescuers alike, results when a workman suffers a fall inside a large grain storage bin or silo. These structures are typically quite tall, sometimes exceeding 90 feet in height, circular, and with very few access hatches. Access hatches are quite small, usually no more than 24 inches wide, are very limited in number, and are ordinarily located on the extreme edge of the structure's roof.

The round concrete storage silo is a feature of many small towns, rural communities, and railroad sidings in grain-producing agricultural areas. These structures are essentially tall right circular cylinders made of reinforced concrete. Storage silos are formed in place by slipforming, a process in which the steel reinforcing rod skeleton is assembled and followed by a moveable slipform (advanced vertically during construction), allowing concrete to be poured (cast) and cured over previously installed reinforcing rod. The slipforming process does not lend itself to wall penetrations, which would have to withstand the pressure of the grain stored within and which would be difficult to access from the exterior of the silo. Consequently, wall access penetrations are rarely present. Access to the silo's interior is ordinarily provided by penetrations in the concrete roof, which may be flat, sloped, or domed. Access hatches are normally immediately adjacent the vertical wall to preserve the greatest structural strength and to limit the possibility of grain damage by rainwater. Concrete storage structures are very strong and durable, but they are labor-intensive and expensive constructions. New concrete silos are rarely built nowadays for cost reasons, but a great many of them remain in operation even after many decades of service.

Contemporary grain storage silo construction is dominated by structures of corrugated sheet metal. Corrugated metal storage silos lack the robust construction of the older concrete silo structures. A typical metal structure is strong enough to be self-supporting when empty and strong enough to withstand the pressures and lateral forces generated by the interior grain column when the structure is full. The roof of the structure is usually fabricated from triangular or trapezoidal metal segments joined along their long sides to form a relatively strong crimped or bolted rib at each joint. The roof is typically a squat truncated cone to facilitate rainwater runoff. Pitch of the roof can be as much as 30° with respect to horizontal. The walls and roof have relatively little rigidity in their own right, making it important to locate access hatches immediately adjacent the silo's vertical wall, which is the strongest and best supported part of the roof.

Virtually all grain storage silos are filled through a downpipe, a circular pipe typically located at the approximate center of the roof. Older concrete storage silos often have a structure called a gantry or Texas house to enclose and protect the downpipe and associated machinery. Corrugated metal silos often have relatively exposed downpipes.

Grain storage silos contain a basic interior structure of platforms, scaffolding, steps, and ladders allowing workmen to enter the silo for maintenance operations and to manipulate the stored grain. Work inside a grain silo is dangerous because of the height, lack of fresh air, grain dust, heat from fermenting grain (if the moisture content is high), the danger of being trapped by loose grain, and other issues peculiar to grain storage structures. One report dealing with grain entrapment statistics is prepared by Purdue University's Agricultural Safety and Health Program¹. In the 2010 summary, the Purdue authors indicate “ . . . no less than 51 grain entrapments occurred in 2010. In addition, there was at least one reported incident of a first responder who required medical treatment due to respiratory issues occurring during a rescue and recovery operation.” Later in the same report: “ . . . this summary does not reflect all grain-related entrapments, fatal or non-fatal that have occurred, due to the lack of a comprehensive reporting system and a continued reluctance on the part of some victims and employers to report partial entrapments where extrication was required but no public report was made.” Still later in the same report: “During 2008, 45% of the entrapments resulted in death with 42% of the entrapments in 2009 resulting in death, and 51% of cases resulting in death in 2010.” Note that these statistics are acknowledged to be incomplete due to variable reporting requirements, and the reports gathered include only information in the United States. ¹ 2010 Summary of Grain Entrapments in the United States, Steve Riedel and Bill Field, Agricultural Safety and Health Program, Purdue University, West Lafayette, Ind., Feb. 9, 2011.

It is evident that an injured worker inside a grain storage structure is in very great jeopardy. Falls inside a grain storage structure often result in broken bones, making it very difficult for the worker to extract himself/herself. A fall into loose grain is similar to a fall into deep loose sand or quicksand—a struggling worker can easily sink into the loose grain and suffocate. A badly injured worker is usually incapable of extricating himself/herself without assistance. Most important, there is only one way out from inside of a grain storage unit-through the roof.

Those called to rescue an injured or trapped worker are likewise at considerable risk. Access hatches are tiny, often no more than 24 inches in diameter, making it very difficult to move equipment into and out of the access hatch and manhandle a badly injured worker inside the structure. An injured worker is usually secured to a SKED™ frame or a backboard to reduce the likelihood of additional injuries during extraction of the injured worker. The injured worker is raised from the grain bed to the access hatch by ropes, an operation that is very dangerous to rescue workers on the outside of the silo, for they must raise a heavy individual while standing on the edge of a sheer vertical drop of as much as 90 feet—possibly more. This lifting operation is additionally complicated by the relative lack of roof strength in a corrugated metal silo, where the strongest parts of the roof are the metal ribs formed by the joints between adjacent roof panels. Once the individual is successfully brought through the access hatch, he/she must be manipulated and repositioned (at the edge of a 90 foot or higher sheer wall), maneuvered over the side, and then carefully lowered to the ground below. Additional injuries can result as a consequence of extraction and manipulation in such confined spaces, and the risk to rescuers remains very high because of the need to manipulate a heavy load at considerable height.

In extreme cases, the worker may die in the silo. In this instance, the effort is properly called a recovery rather than a rescue, but the risks to the recovery team remains the same. For the sake of brevity, all such operations will be considered rescue operations in this specification.

Grain storage facilities are very commonly located in relatively remote locations with few trained rescue resources. At the present time, trained rescue workers must transport their own equipment to an accident site, thereby consuming valuable time that may be badly needed for treatment of an injured worker. It is therefore highly desirable for rescue equipment to be relatively inexpensive so that individual gain storage facilities can readily afford to have rescue equipment available on site, allowing other grain storage facility workers to erect the rescue structure while rescue workers are en route. Failing this, it is highly desirable that the rescue structure be portable and capable of rapid yet safe erection by rescue personnel when they arrive on site. Accordingly, there is a need for rescue apparatus which may be used in the very high and confined spaces of grain storage silos and storage bins

### DETAILED DESCRIPTION OF THE PREFERRED EMBODIMENTS

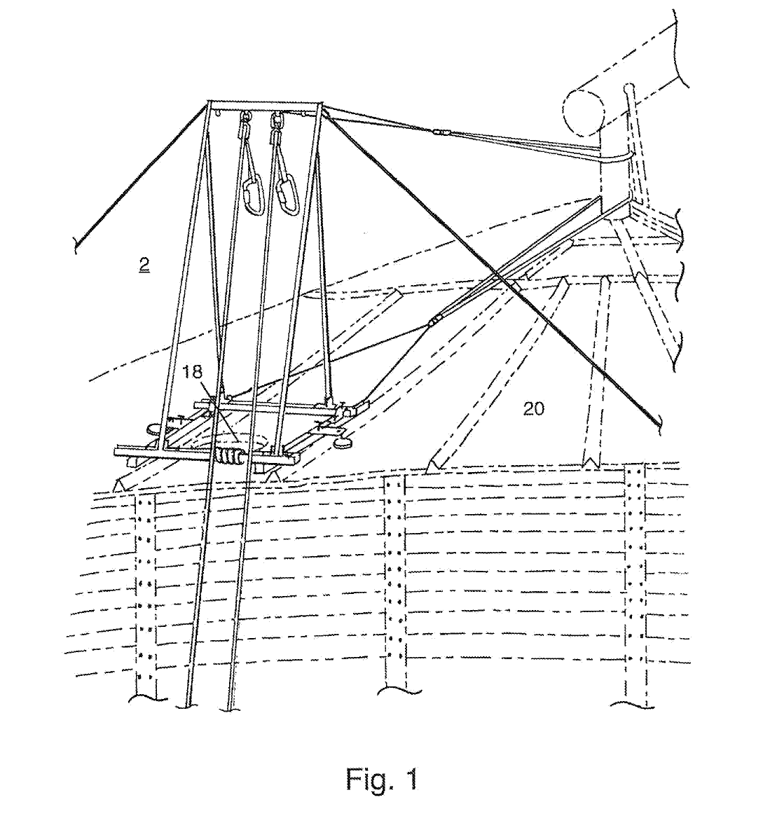

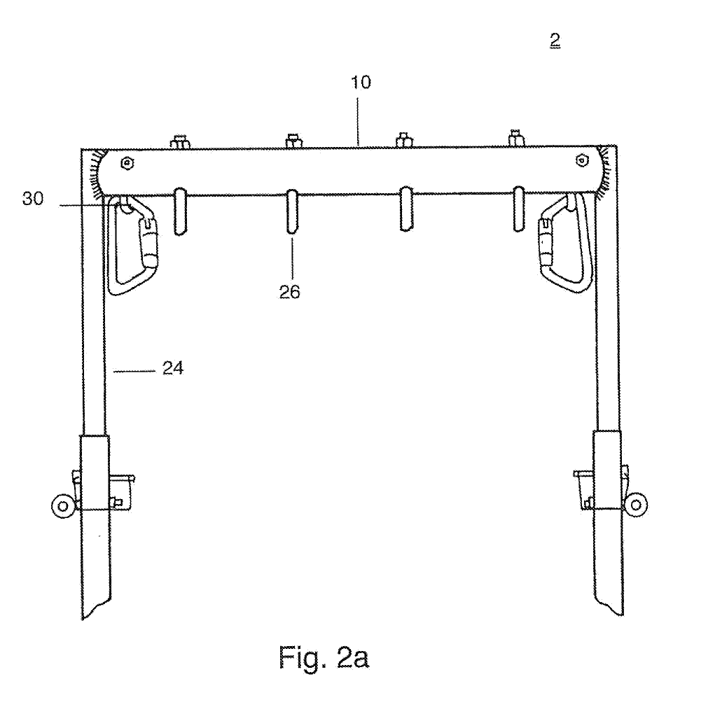

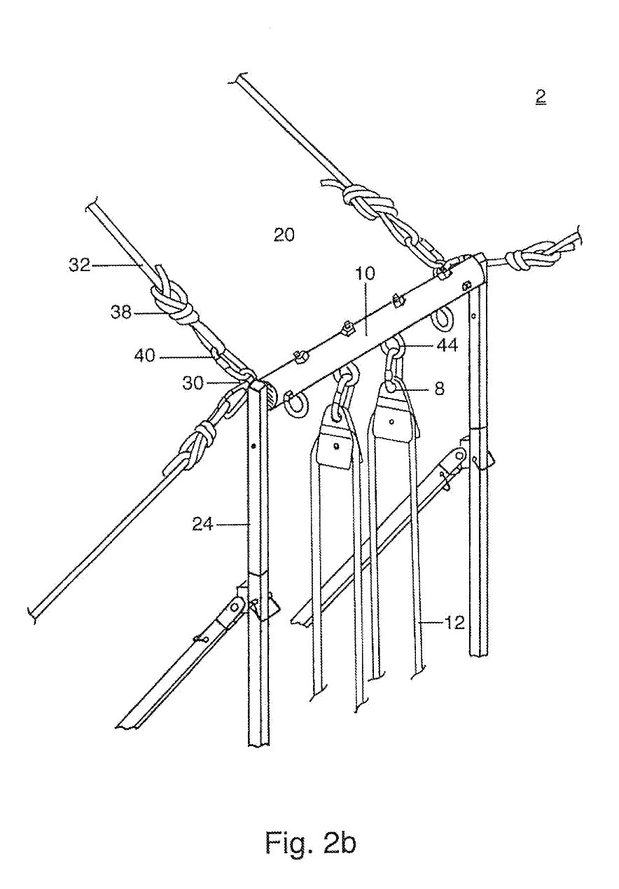

FIG. 1 is a rendering of the invention, rescue apparatus 42, installed on the top edge of a corrugated metal grain bin's roof 20. FIGS. 1-3 show the basic structural features of rescue apparatus 42 comprising a hoisting frame 2; rear bracing members 4 behind the hoisting frame 2; one or more security lines 6 to provide bracing and mechanical stability for the hoisting frame 2; pulleys 8 (two are shown in FIG. 2b) of various sizes and functions to be described later which are suspended from the top horizontal member 10 of the hoisting frame 2; ropes or cables (referred to generically as ropes 12 in this specification) each having a first end 14 and a second end 16, the first end 14 of the ropes 12 passing through the pulleys 8 into the access hatch 18; a generally trapezoidal, rectangular, or square bottom frame 50 which adapts the rescue apparatus 42 for mounting to the roof 20 of the grain storage structure; and one or more adjustable rear brace elements 22 which position the hoisting frame 2 in a vertical orientation. These and other features will be described in detail in the paragraphs which follow.

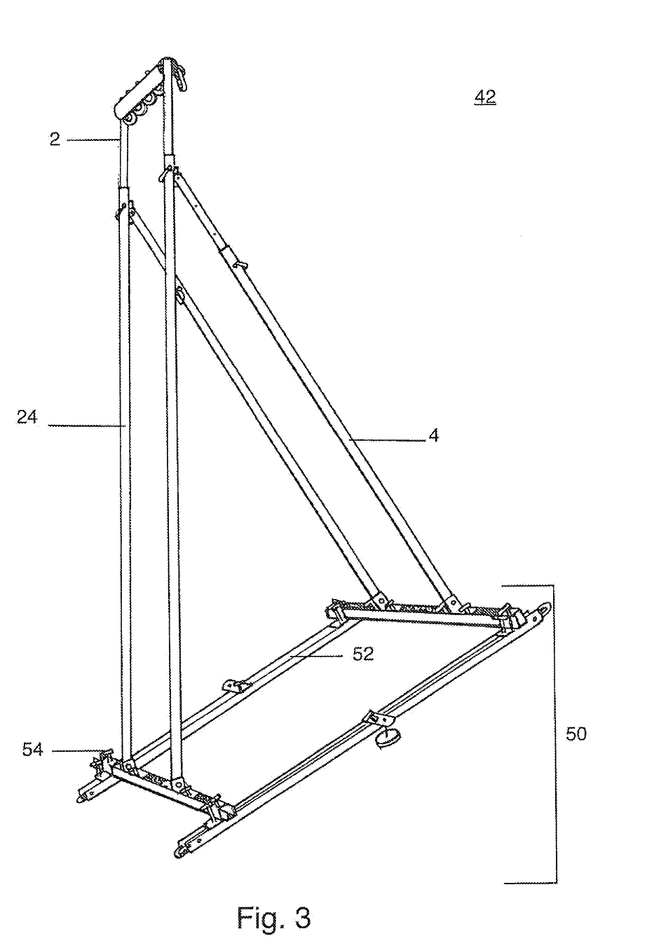

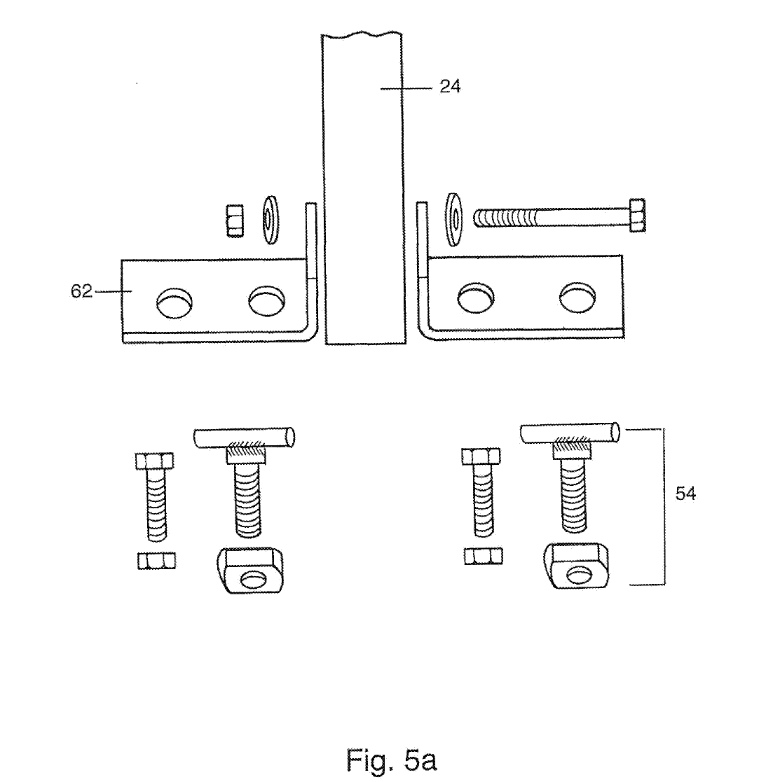

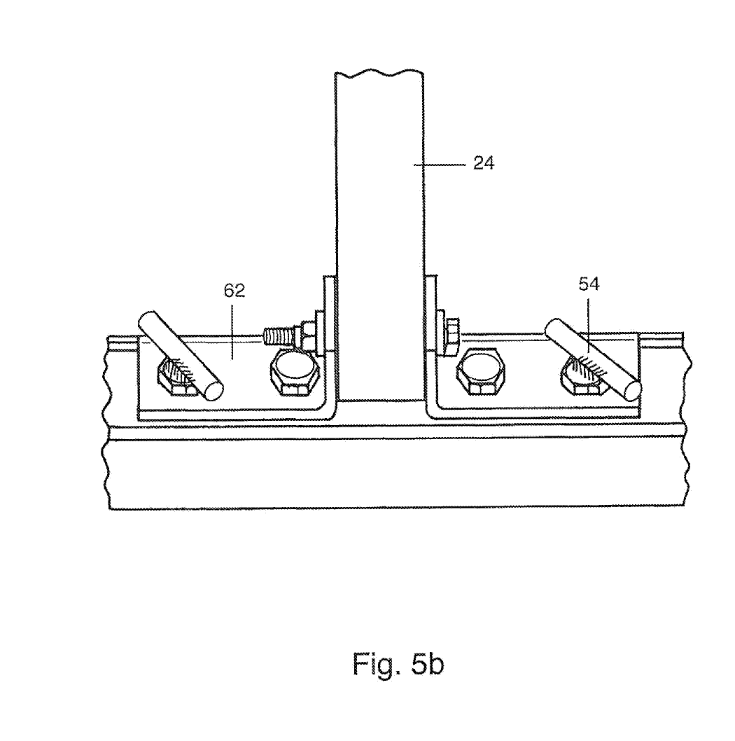

FIG. 2a and FIG. 2b show the hoisting frame 2 in greater detail. The hoisting frame 2 comprises one top horizontal member 10 and two vertical members 24, the top horizontal member 10 and the vertical members 24 each made of metal tubing, typically steel or a high-strength aluminum alloy with square, circular, or rectangular cross-section. The top horizontal member 10 and the two vertical members 24 are made of steel or aluminum in the preferred embodiment. A plurality of eye bolts 44 of various sizes and functions to be described later are securely attached to the top horizontal member 10. The open side of the hoisting frame 2 nearest the roof 20 is considered the bottom of the hoisting frame 2. As shown in FIG. 3 and later in FIG. 5a, the lower terminus of each of the two vertical members 24 contains holes drilled to receive coupling fasteners 28 and tee-handled bolts 54 associated with the bottom frame 50 to be described in detail later.

In the preferred embodiment shown in FIGS. 1-3, two eye bolts called the security eye bolts 30 at the extreme ends of the top horizontal member 10 each are installed through two holes oriented to permit the shaft of the security eye bolts 30 to pass through the top horizontal member 10 in a substantially horizontal orientation. The security eye bolts 30 are normally attached to two or more security ropes or security lines 32, each with a first end 34 and a second end 36. Two security lines 32 are used in the preferred embodiment. The first end 34 of each security line 32 is, in the preferred embodiment, terminated in a loop 38, preferably formed by a knot known as a figure eight on a bight. In the preferred embodiment, a carabiner 40 is installed during setup of the rescue apparatus 42 to pass through the loop 38 of each security rope 32 and the eye of a security eye bolt 30, forming a strong yet flexible linkage. In the preferred embodiment, the second end of each security line 36 is attached to a strong structure or object (not shown) to provide lateral support for the hoisting frame 2. As shown in FIG. 1, the security ropes 32 are preferentially installed so that the security ropes 32 are at an angle of substantially 45 degrees with respect to the vertical members 24 of the hoisting frame 2. The actual angle of installation must be selected in conformity with the structures and objects available in a given location, and the particular circumstances at a given location may compel a particular angle.

With continued reference to FIG. 2a and FIG. 2b, four of the pulley eye bolts 44 are shown. The four pulley eye bolts 44 are mounted between the two security eye bolts 30 along the top horizontal member 10, and each of the pulley eye bolts 44 is installed through two holes oriented in such as way as to permit the shaft of the pulley eye bolts 44 to pass through the top horizontal member 10 in a substantially vertical orientation. A carabiner 40 is optionally installed during setup of the rescue apparatus 42 to pass through the eye of each pulley eye bolt 44 and the eye of a pulley 8, forming a strong yet flexible linkage. As shown in FIG. 1 and FIG. 2b, strong flexible ropes 12 running through the pulleys 8 serve various functions. As shown, one rope 12 through one pulley 8 is used to support, raise, lower, and otherwise manipulate the accident victim, rope 12 through another pulley 8 is used for backup and belaying of the accident victim, and ropes 12 through two other pulleys 8 are used as support and extraction lines for rescue workers inside the grain storage silo.

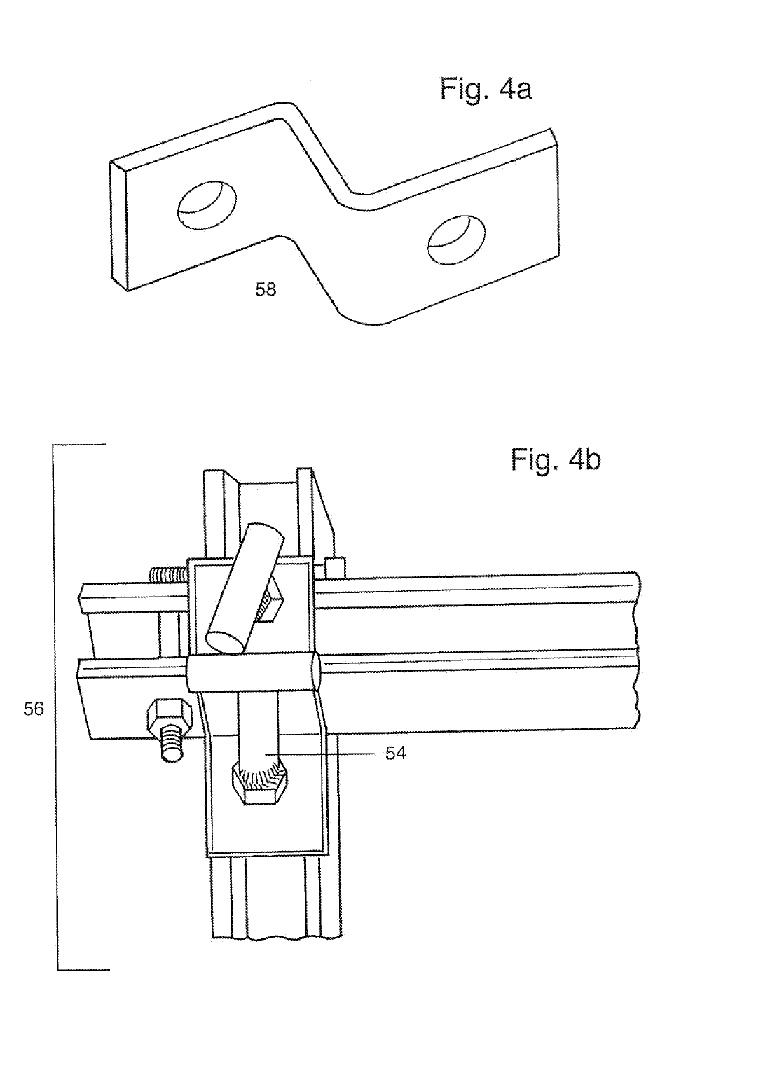

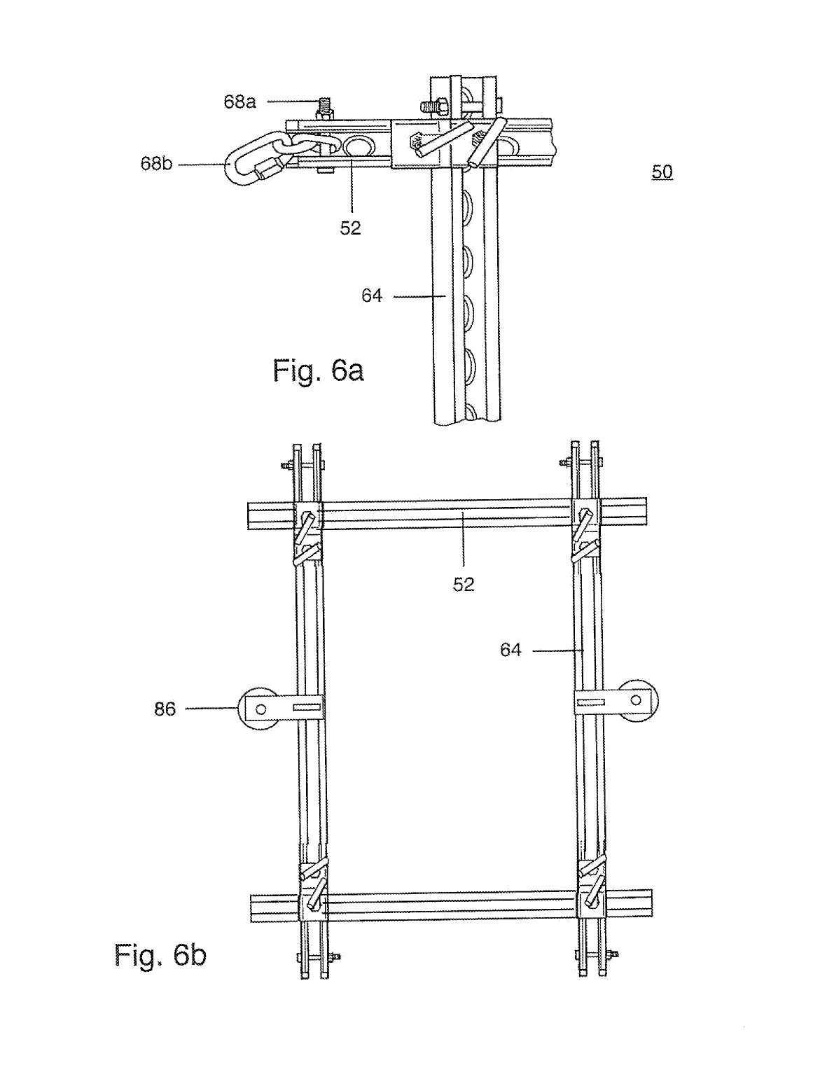

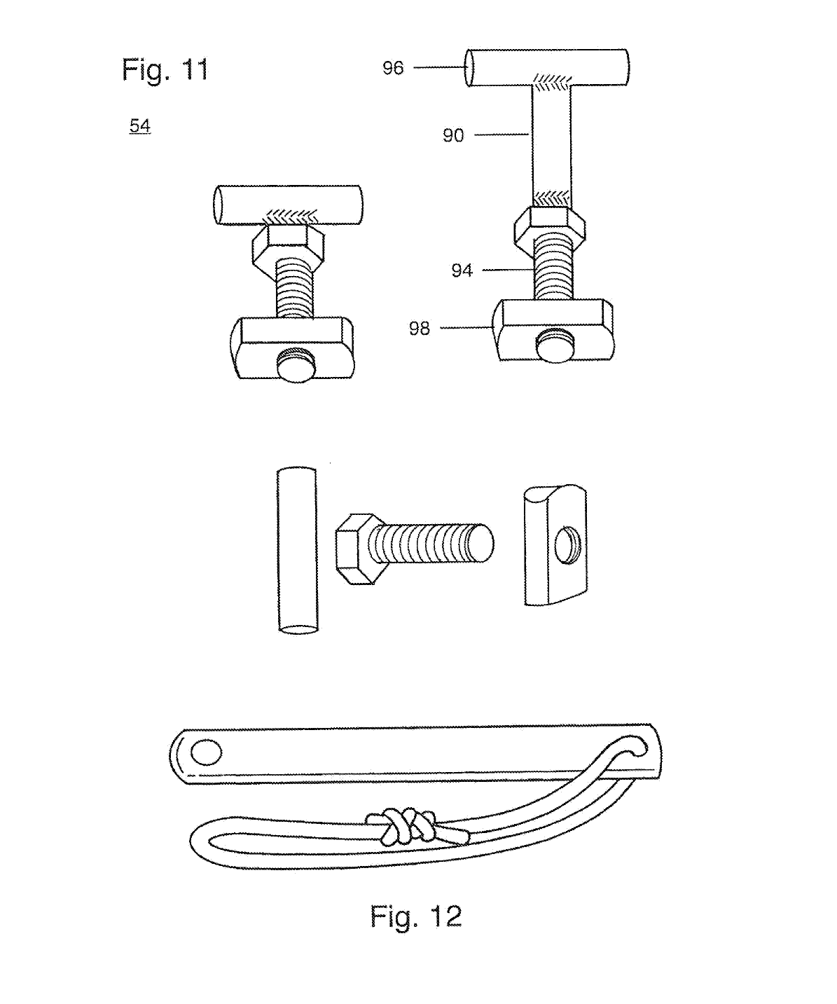

FIG. 1 and FIG. 3 illustrate how the hoisting frame 2 is operably connected to one or more rear bracing members 4 (to be described in greater detail later) and, in most circumstances, a square or rectangular bottom frame 50 which will now be described. In the preferred embodiment, the bottom frame 50 is fabricated from steel or aluminum tubing of generally square or rectangular cross section with a slot extending the entire length of one side to form a structural unit called a frame rail 52. Slots in the frame rail 52, shown in close-up in FIG. 4b and FIG. 6a, provide a means for strong, rapid alignment of the frame elements using bolts or other fasteners. In the preferred embodiment, tee-handled bolts 54 (or tee-handled fasteners 54) as shown in FIG. 4b, FIG. 5a, FIG. 11, and other places, are greatly preferred and will be described in greater detail hereafter. These fasteners are sometimes called slotted rail fasteners 54 in this specification. Many types of fasteners are available to those practicing the mechanical arts and any suitable faster is considered to lie within the scope of this invention.

A Z-shaped frame bracket assembly 56, shown in FIG. 4b, is used to establish and securably maintain a desired spacing between two sides of the bottom frame 50. The Z-shaped frame bracket assembly 56 derives its name from the Z-shaped frame bracket's 58 cross-section, shown in FIG. 4a, which contains two substantially 90° bends and approximates the letter Z. The Z-shaped frame bracket 58 contain two holes through which pass the shafts of two bolts or fasteners which engage the slots in one or more slotted frame rails 52. The tee-handled bolts or slotted rail fasteners 54 may be securely preinstalled in the holes in the Z-shaped frame bracket assembly, 56 so that they will not fall out during transport and assembly of the slotted frame rails 52.

An L-shaped frame bracket assembly 60, shown in FIG. 5a and FIG. 5b, is also used to establish and securably maintain the desired spacing of elements of the rescue apparatus 42. As shown, each L-shaped frame bracket assembly 60 comprises at least one slotted-rail faster 54 and holes for at least one additional fastener which joins other elements of the rescue apparatus 42 to a slotted frame rail 52. The L-shaped frame bracket assembly 60 derives its name from the L-shaped frame bracket's 62 cross-section, which contains a single substantially 90° angle and approximates the letter L. The slotted rail fasteners 52 may be securely preinstalled in holes in the L-shaped frame bracket assembly so they will not fall out during transport and assembly of the slotted frame rails 52.

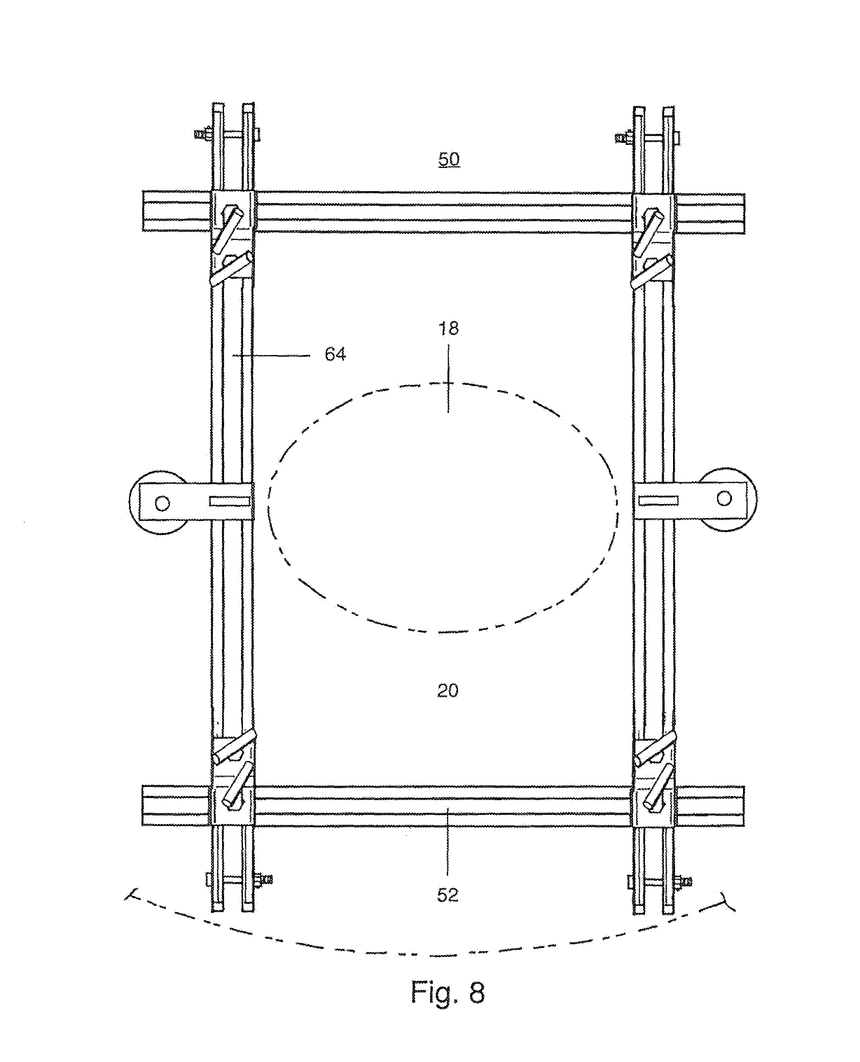

With reference now to FIGS. 6b and 8, the basic bottom frame 50 structure is assembled from four slotted frame rails 52. Two slotted frame rails 52 (the bottom-most slotted frame rails 64, closest to the roof 20) are situated to be approximately parallel and substantially normal to the vertical edge of the grain storage structure with the frame rail slots facing up. Two more slotted frame rails 52 (the top-most slotted frame rails 66) are then placed generally perpendicular (normal) to the bottom-most slotted frame rails 64 and parallel to one another, giving the top-most slotted frame rails 66 a generally tangent or parallel alignment with the vertical edge of the grain storage structure. The bottom-most slotted frame rails 64 are positioned to provide the greatest structural support for the weight of the rescue apparatus, the injured worker, and the rescue workers. The top-most slotted frame rails 66 are then positioned on top of the bottom-most slotted frame rails 64 with the frame rail slots facing up so that the bottom-most 64 and top-most 66 slotted frame rails may be secured in a rectangle or parallelogram. The bottom-most 64 and top-most 66 slotted frame rails are then joined together using the Z-shaped frame bracket assemblies 56 previously described (see FIG. 6b and FIG. 8).

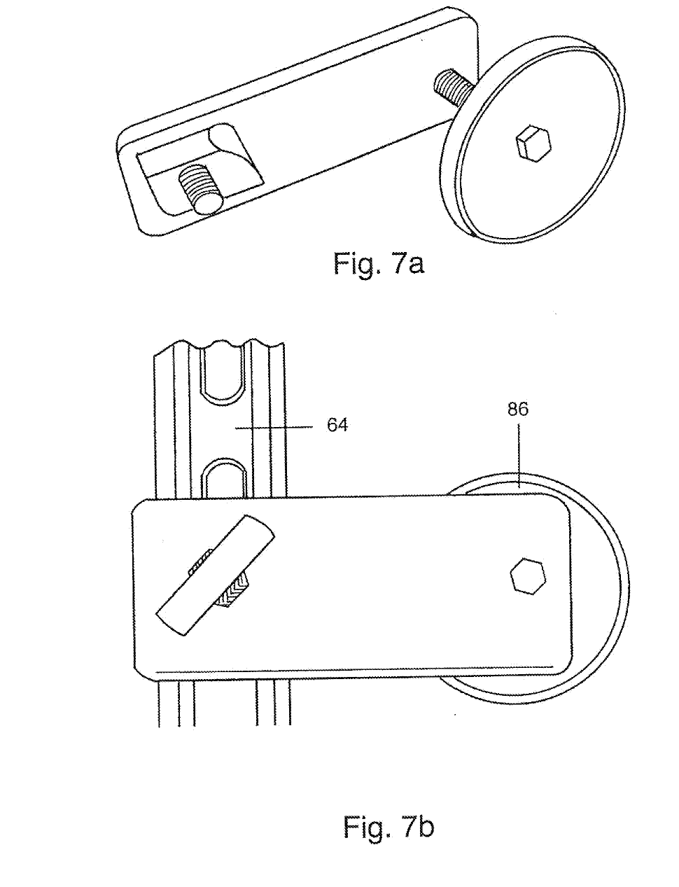

In the particular case of installing the rescue apparatus 42 on a ribbed metal grain bin roof, as shown in FIG. 1, at least two bottom-most slotted frame rails 64 are spaced as far apart as possible and positioned to fit between the ribbed sections of the grain bin roof. It is highly advantageous to install one or more anchoring pad assemblies 70, illustrated in detail in FIGS. 7a and 7b, each comprising a pad mounting bracket 72, a magnet cup 74 attached to mounting bracket 72 by a magnet cup fastener 76, and a large strong magnet 86, to the bottom-most slotted frame rails 64 to hold the bottom-most slotted frame rails 64 in place on the metal roof while attaching the two bottom-most slotted frame rails 64. As shown, each bottom-most slotted frame rail 64 will have at least one anchoring pad assembly 70. Anchoring pad assembly 70 is attached to the bottom-most slotted frame rail 64 by a tee-handled bolt 54. The tee-handled bolt 54 is securely pre-installed in the hole of the anchoring pad assembly 70 so it will not fall out during transport and assembly. The top-most slotted frame rails 66 are then positioned on top of the bottom-most slotted frame rails 64 with the frame rail slots facing up so that the bottom-most 64 and top-most 66 slotted frame rails may be secured in a rectangle or parallelogram. The top-most slotted frame rails 66 are parallel to one another, thereby providing the greatest structural strength to the rescue apparatus 42. The bottom-most 64 and top-most 66 slotted frame rails are then joined together using the Z-shaped frame bracket assemblies 56 previously described.

Also in the particular case of installing the rescue apparatus 42 on a ribbed metal grain bin roof, great care must be taken to insure that the roof structure has sufficient strength to support the weight of the rescue workers, the injured worker, and the rescue apparatus 42. As previously noted, metal grain storage bins are constructed of relatively thin metal and the design is intended to contain forces of the grain stored within, winds, and roof loads such as rainwater and snow. Grain storage structures are, by their very nature, continually exposed to the weather and will corrode and otherwise degrade in strength over time. When the structural strength of the grain storage bin roof is believed to be compromised, it is highly desirable to use an embodiment comprising more than two bottom-most slotted frame rails 64 (not shown). Additional bottom-most slotted frame rails 64 are commonly positioned to fit near to and on either side of more than one ribbed sections of the grain bin roof. This increases the load-bearing capacity of the bottom frame assembly 50 by providing additional surface area to support the weight of the rescue workers, the injured worker, and the rescue apparatus 42. As described previously, large strong magnets 86 in one or more anchoring pad assemblies 70 are attached to the bottom-most frame rails 64 to hold them in place on the metal roof while attaching the top-most slotted frame rails 66. The top-most slotted frame rails 66 are positioned on top of the bottom-most slotted frame rails 64 with the frame rail slots facing up so that the bottom-most 64 and top-most 66 slotted frame rails may be secured in an arrangement generally approximating a rectangle or parallelogram. The top-most slotted frame rails 66 are preferably parallel to one another, thereby providing the greatest structural strength to the rescue apparatus 42. The bottom-most 64 and top-most 66 slotted frame rails are preferably joined together using the Z-shaped frame bracket assemblies 56 previously described.

Each of the individual slotted frame rail assemblies 52 contains holes at the extreme ends drilled in such a way that a fastener, typically a bolt, passed therethrough will extend in a generally horizontal plane. These fasteners serve as additional attachment points for short lengths of chain 68, which are in turn used with carabiners 40 passed though the loops 38 of additional security ropes 32. This arrangement is shown in FIG. 6a.

The number of slotted frame rails 52 in the bottom frame 50 assembly is not a limitation of the invention. In the first and second preferred embodiments, at least two top-most slotted frame rails 66, forming two opposing sides of the bottom frame 50, will be parallel. While this parallel arrangement is not a requirement of the invention, it is a preferred arrangement with certain structural advantages. The number of slotted frame rails 52 in the bottom frame 50 assembly is not a limitation of the invention, although if some number other than four slotted frame rails 52 are used the assembly sequence given above must be modified appropriately.

The vertical members 24 of the previously discussed hoisting frame 2 contain two mounting holes located to match the holes in the L-shaped frame brackets 62 (see FIG. 5a and FIG. 5b). Once assembly of bottom frame 50 is complete, the holes in the bottom of the hoisting frame's 2 vertical members 24 are attached to the bottom frame 50 assembly using two L-shaped frame brackets 62 and slotted rail fasteners 54 as shown in FIG. 5a and FIG. 5b. Preferably, all L-shaped frame bracket assemblies 60 are premounted to the vertical members 24 of the hoisting frame 2 to save time in assembly at the accident site. As discussed previously, slotted rail fasteners 54 are securely pre-mounted to the L-shaped frame brackets 62 to prevent loss during transport and to achieve faster assembly at the rescue site. The vertical members 24 of the hoisting frame 2 are fastened to the L-shaped frame bracket assemblies 60 in a way permitting relative rotation of the hoisting frame 2 with respect to the bottom frame 50 for reasons which soon will be apparent.

The lifting frame 2 should be mounted in a substantially vertical plane near the vertical edge of the grain storage structure. This arrangement allows the ropes 12 associated with the pulleys 8 to be passed directly through the access hatch 18 to the interior of the grain storage structure. Forces applied to the ropes 12 are transferred by the pulleys 8 to lower rescue workers into the grain storage structure, to raise the injured worker, and to extract the rescue workers from the grain storage structure. When the injured worker is raised through the access hatch 18 and is completely above the edge of the roof 20, the SKED™ or backboard is readily manipulated to pass the injured worker between the vertical members 24 of the hoisting frame 2 and then be lowered to medical personnel on the ground. This manipulation may be done with little or no effort on the part of roof-mounted rescue personnel, for the forces to raise and lower the injured worker and the rescue workers may be generated at ground level by a compound pulley system (not shown) operated by rescue team members or similar devices. Rescue workers on the roof of the grain storage structure need only move and exert sufficient forces to manipulate and redirect or reposition an injured worker who is otherwise supported by the ropes 12, pulleys 8, and the hoisting frame 2. Powered winches could be used to generate the forces needed to raise and lower the injured worker and rescue workers, and powered winches are considered to be within the scope of this invention. Rescue teams ordinarily do not use powered winches when raising or lowering victims or rescuers because of the risk of serious injury or death if the victim or rescuer is caught on a structural member and the powered winch cannot be immediately shut down.

If the hoisting frame 2 is to be securely mounted in a substantially vertical orientation, the hoisting frame 2 and bottom frame 50 must be capable of relative articulation so hoisting frame 2 may be raised as necessary to be substantially vertical while the bottom frame 50 must match the pitch of the grain storage structure's roof 20. This is readily seen in FIG. 3. As previously noted, the roof 20 pitch can be 30° or more with respect to the horizontal. The bottom frame 50 and ropes 32 attached to the security eyebolts 30 on the top horizontal member 10 of the hoisting frame 2 contribute to lateral stability, but securely maintaining the hoisting frame 2 in a near-vertical orientation requires rear bracing members 4 joining the hoisting frame 2 to the bottom frame 50. These rear bracing members 4 are joined to the bottom frame 50 using the arrangement of mounting holes positioned to match holes in the L-shaped frame bracket assemblies 60. As shown in FIG. 3, the rear bracing members 4 are attached to the bottom frame 50 assembly using two L-shaped frame brackets 62 and slotted rail fasteners 54 similar to the arrangement shown in FIG. 5a and FIG. 5b. In the preferred embodiments, the two L-shaped frame bracket assemblies 60 are premounted to the vertical members 24 of the hoisting frame 2 to save time in assembly. As discussed previously, slotted rail fasteners 54 are securely pre-mounted to the L-shaped frame brackets 62 to prevent loss during transport and to achieve faster assembly at the rescue site. Because the rear bracing members 4 must assume different positions according to the pitch of the grain storage structure roof 20, it is important to fasten the rear bracing members 4 to the L-shaped frame bracket assemblies 60 in a way permitting relative rotation of hoisting frame 2 with respect to the bottom frame 50. This allows the mechanical structure of a single rescue apparatus 42 to adapt to all roof 20 geometries. An illustration simulating the proper orientation of the hoisting frame 2, bottom frame 50, and rear bracing members 4 with a roof 20 pitch of approximately 30° is shown in FIG. 3.

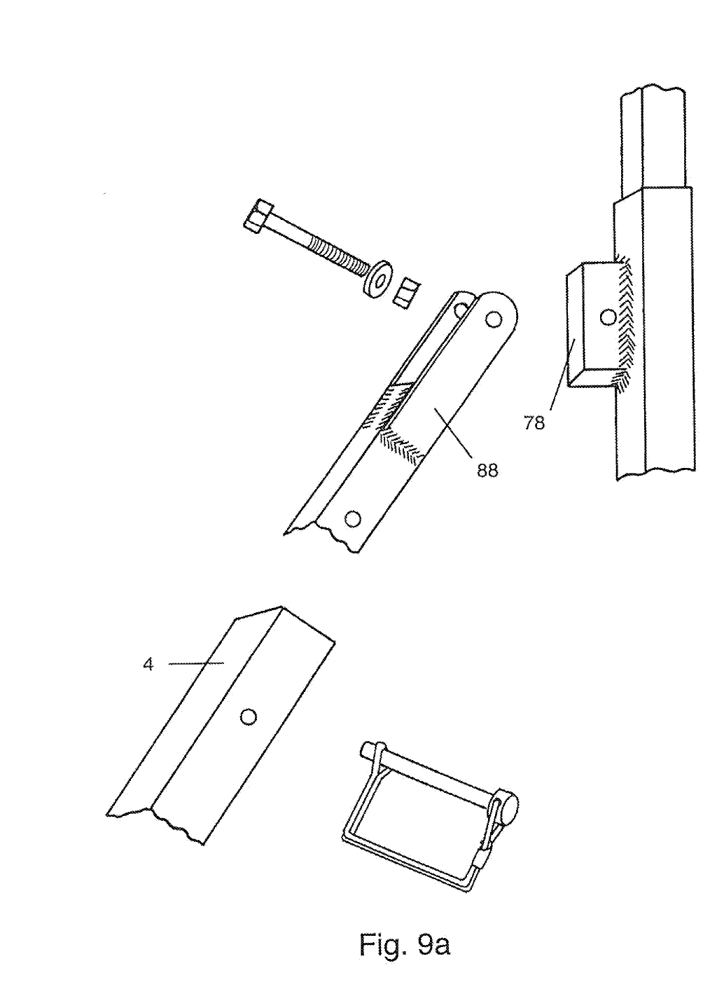

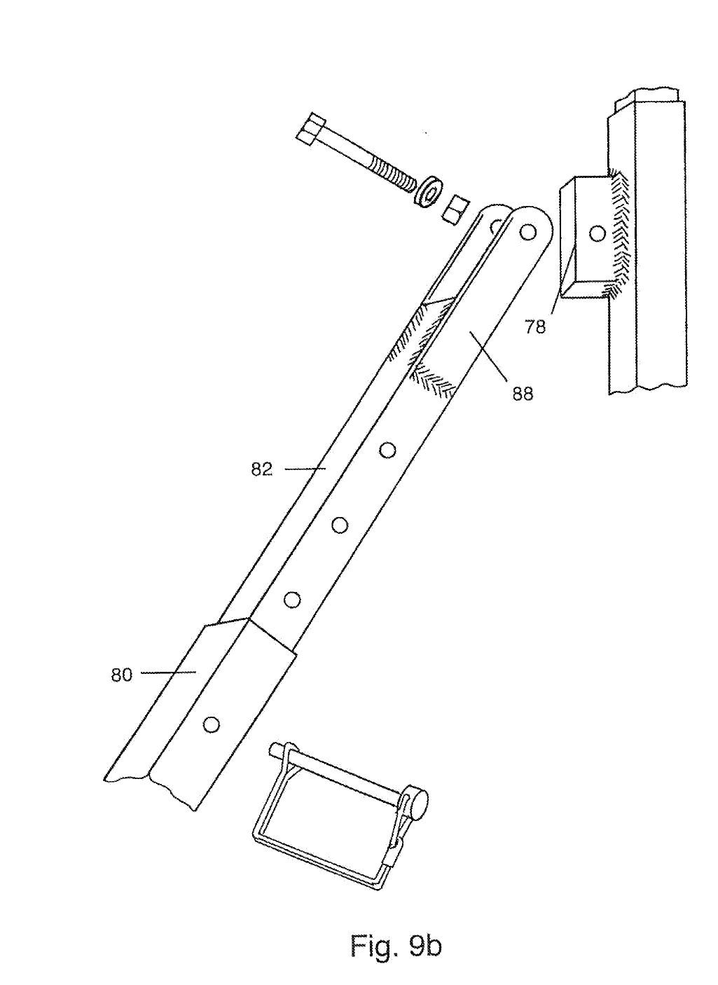

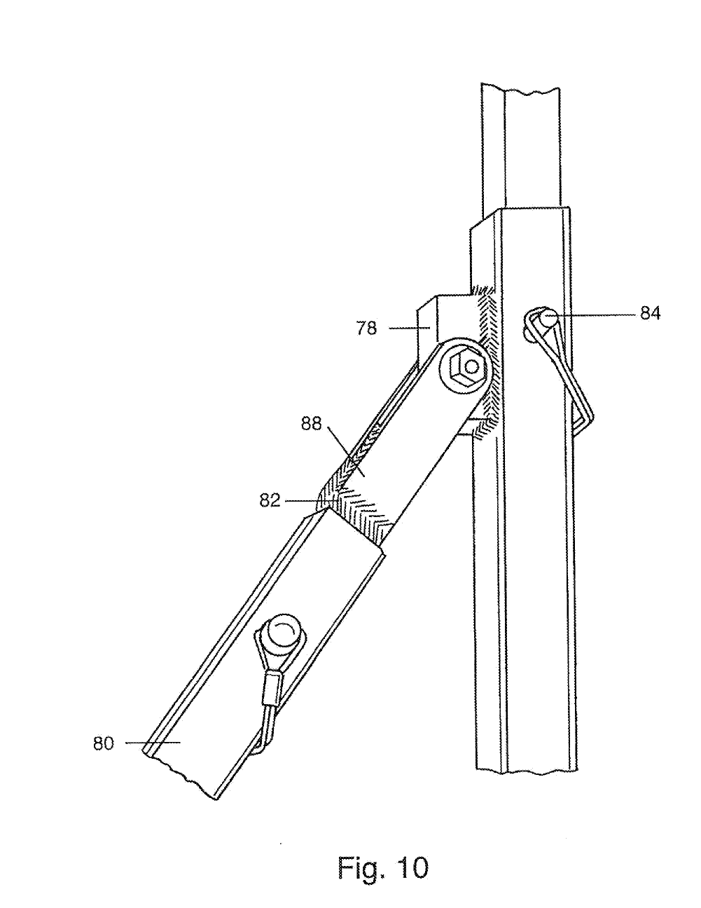

The rear bracing members 4 may be rigidly attached to the vertical members 24 of the lifting frame and the bottom frame 50 to form a strong, secure triangular box structure. A clevis or slotted terminal bracket 88 at the top of each rear bracing member 4 is attached to an anchor or mounting ear 78 welded or otherwise attached to each vertical member 24 of the hoisting frame 2, as shown in FIG. 9a, FIG. 9b, and FIG. 10. Because the rear bracing members 4 must assume different positions according to the pitch of the grain storage structure roof 20, it is important to fasten the rear bracing members 4 to the anchors or mounting ears 78 with a bolt or other fastener in a way permitting relative rotation of hoisting frame 2 with respect to the bottom frame 50. This allows the mechanical structure of a single item of rescue apparatus 42 to adapt to all roof 20 geometries.

The length of each rear bracing member 4 is adjusted to lengthen or shorten the rear bracing member 4 to conform to the geometry required by the roof 20 pitch. As shown most clearly in FIG. 9b, this is done using an external rear bracing member element 80, constructed of square or rectangular steel or aluminum tubing, and an internal rear bracing member element 82, also constructed of square or rectangular steel or aluminum tubing. Dimensions of the external 80 and internal 82 rear bracing member elements are such that the internal rear bracing member element 82 is slideably supported within the interior of the external rear bracing member element 80. The external rear bracing member element 80 has two opposing holes for a tractor pin 84, and the internal rear bracing member element 82 has two rows of opposing holes along the length of the internal rear bracing member element's 82 tubing. In a preferred embodiment, the rows of clearance holes comprise 11/32-inch diameter holes having regular 4½-inch center-to-center spacing which are sufficient to pass a 5/16-inch by 2¼-inch tractor pin. The hoisting frame 2 is raised into a substantially vertical position with the tractor pin 84 removed from each rear bracing member 4. When the hoisting frame 2 is in the proper position, the tractor pin 84 is inserted into the appropriate holes in the external 80 and internal 82 rear bracing member elements, pinning them together and rendering the external 80 and internal 82 rear bracing member elements effectively a strong single rear bracing member element 4. In this way, the rescue apparatus 42 is essentially a top horizontal member 10 with eye bolts 30 associated with security and stability, other eye bolts 44 supporting pulleys 8, and a very strong triangular box structure consisting of the hoisting frame's 2 vertical members 24, the bottom frame 50, and the rear bracing members 4. Lateral stability is provided by a variety of ropes 12 anchored to strong structures and objects (not shown) which may be available at a particular grain storage installation.

Vertical adjustment of the top horizontal member 10 of the hoisting frame 2 is provided by adjusting the length of the rear bracing members 4. Examination of FIG. 10 will reveal the tractor pin 84, located immediately to the right of the anchor or mounting ear 78, used to adjust the height of the top horizontal member 10.

Tractor pins 84 are used in the preferred embodiment, for they have many desirable features in the rescue apparatus 42 application. Tractor pins 84, tee-handled bolts 54, carabiners 40, eye bolts 30 and 44, and other coupling fasteners 28 are hardware items used to join, link, attach, secure, and otherwise carry out the functions described in the preferred embodiment. Those skilled in the mechanical arts are aware of a great many other fasteners and devices which may be employed to carry out the required functions. Fasteners and devices other than those recited above are held to be within the scope of the invention.

Tee-handled bolts 54 are especially useful. As may be seen in greater detail in FIG. 11, a tee-handled bolt comprises a relatively long shaft 90 having a first end 92 and a second end 94 which may be either partially or completely threaded. A crosspiece or handle 96 is joined to the first end 92 of the tee-handled bolt 54, providing a convenient grip and lever arm to permit application of torque to securely tighten the tee-handled bolt 54 in place. A threaded keeper nut 98 is threadably engaged to the second end 94 of the tee-handled bolt 54. The threaded keeper nut 98 may assume any one of several geometrical shapes allowing the threaded keeper nut 98 to rapidly pass through the slot in a slotted frame rail 52. Once through the slot of the slotted frame rail 52, the crosspiece (handle) 96 of the tee-bolt 54 is turned to tighten the threaded keeper nut 98 against the interior of the slotted frame rail 52. The geometry and frictional fit of the threaded keeper nut 98 is such that, when the threaded keeper nut 98 is not touching the interior wall of the slotted frame rail 52, tightening the tee-bolt shaft 90 produces relative motion of the threaded keeper nut 98 within the interior of the slotted frame rail 52, thereby misaligning the threaded keeper nut 98 with respect to the slot in the slotted frame rail 52 and preventing removal of the threaded keeper nut 98 through the slot in the slotted frame rail 52. A variety of geometrical shapes could be used for the body of threaded keeper nut 98; in the embodiments described in this specification the threaded keeper nuts 98 are generally rectangular with rounded edges. Other suitable geometries are to be considered within the scope of this invention.

The heights of the shafts 90 of tee-bolts 54 may be staggered to prevent interference of the handles 96 when multiples tee-bolts 54 are used in a single assembly. Relative dimensions illustrating this practice are shown in FIG. 11. This preferred practice is best seen in FIG. 4b and FIG. 6a, where the tee-bolt 54 securing the Z-shaped frame bracket 58 to the bottom-most slotted frame rail 64 has a shaft 90 considerably longer than the tee-bolt 54 used to secure the Z-shaped frame bracket 58 to the top-most slotted frame rail 66. This length difference in tee-bolt shaft length 90 greatly facilitates speed and ease of assembly.

Experimentation has shown that controlled friction between the second end 94 of the tee-bolt 54 and the threaded keeper nut 98 threaded thereon is sufficient to prevent separation of the two pieces. This allows the threaded keeper nut 98 to remain engaged with the second end 94 of the tee-bolt 54 during transportation and storage. During assembly of bottom frame 50, the threaded keeper nuts 98 are simply passed through the slots in the slotted frame rails 52 and are then rapidly secured by a few turns of the tee-bolt handle 96. This is a significant advantage when assembling the rescue apparatus 42 on a sloping roof 20 some 90 feet or more in the air-erection of the rescue apparatus 42 is accomplished in minimum time and the risk of a threaded keeper nut 98 being lost or falling to the ground, thereby delaying assembly of the rescue apparatus 42, is greatly reduced.

A simple flat wrench 102 may be used to tighten or loosen tee-bolts 54. As shown in FIG. 12, the wrench 102 is a simple rectangular piece of metal with a first and a second hole positioned near the opposing first and second smaller sides of the rectangular metal piece, respectively. Width of the wrench 102 is sufficient to give the wrench 102 strength for its task, but is held to a minimum so that wrench 102 is not subject to interference by other tee-bolt handles 96 in the vicinity of the tee-bolt handle 96 being tightened. In the preferred embodiment, the first hole with a diameter of substantially %-inch is centered substantially ¾-inch from the first smaller side of wrench 102; this hole is used to engage the tee-bolt handle 96. The second hole with a diameter of substantially ¼-inch is centered substantially ½-inch from the second smaller side of wrench 102. As shown, a short security strap 100 passes through the second hole and is often provided with a carabiner 40 (not shown) to provide secure attachment to the rescue worker's belt. In the preferred embodiment, wrench 102 is made from a rectangular piece of mild steel with dimensions of substantially 8½-inches long, 1-inch wide, and ¼ inch thick. The wrench material, geometry, dimensions, and hole diameters are not critical and the material, geometry, and dimensions of the preferred embodiment should not be interpreted as being limiting in any way.

Various modifications can be made in the design and operation of the present invention without departing from its spirit. Thus, while the principal preferred construction and modes of operation of the invention have been explained in what is now considered to represent its best embodiments, it should be understood that within the scope of the appended claims, the invention may be practiced otherwise than as specifically illustrated and described.

What is claimed is:

1. An apparatus for rescuing persons and objects from a grain storage bin or similar structure, the apparatus comprising:
a bottom frame;
a hoisting frame comprising:
a top horizontal member comprising at least one attachment location adapted to support a safety mechanism; and
a plurality of legs, each leg comprising a first end and a second end;
wherein the first ends of the plurality of legs are attachable to the top horizontal member, and
wherein the second ends of the plurality of legs are rotatably attached to the bottom frame; and
at least one rear bracing member each comprising a first end and a second end;
wherein the first end is securable to an anchor; and
wherein the second end is rotatably attached to the bottom frame.

2. The apparatus of claim 1 wherein at least one rear bracing member provides an adjustable length.

3. The apparatus of claim 2 wherein the anchor is mounted on the hoisting frame.

4. The apparatus of claim 3 wherein the anchor comprises a portion of a clevis.

5. The apparatus of claim 1 wherein the legs provide an adjustable length.

6. The apparatus of claim 1 wherein the bottom frame comprises a frame rail.

7. The apparatus of claim 6 wherein the frame rail comprises hollow tubing.

8. The apparatus of claim 7 wherein the frame rail comprises a slot parallel to a major axis of the frame rail.

9. The apparatus of claim 6 wherein the frame rail comprises a rectangular cross-section.

10. The apparatus of claim 9 wherein a plurality of frame rails are maintained in relative alignment by a frame rail bracket assembly comprising a first end portion, a middle portion, and a second end portion, the first and second end portions being separated from the middle portion by substantially 90° bends, the first and second end portions being displaced in opposite directions from the middle portion, the first and second end portions each having at least one hole to receive a fastener.

11. The apparatus of claim 1 wherein the second ends of the legs and second ends of the rear bracing members are rotatably attached to the bottom frame by a frame rail bracket comprising a first end and a second end, the first and second ends being separated by a substantially 90° bend, the first and second end portions each having at least one hole to receive a fastener.

12. The apparatus of claim 11 in which the fastener is a tee-handle fastener.

13. The apparatus of claim 1 wherein the safety mechanism comprises at least one pulley.

14. The apparatus of claim 1 wherein the hoisting frame is adapted to receive one or more security lines;
each security line having a first end and a second end;
wherein the first end of each security line is securable to the hoisting frame.

15. The apparatus of claim 1 wherein the bottom frame is adapted to secure one or more security lines.

16. The apparatus of claim 15 wherein the one or more security lines are further secured at a grain storage bin's access hatch.

17. A method for rescuing persons and objects from a grain storage bin comprising an access hatch, the steps comprising:
lifting a safety apparatus to the roof of the grain storage bin, the safety apparatus comprising a bottom frame and a pulley assembly;
assembling the bottom frame to circumscribe the access hatch;
securing a first end of a security line to the pulley assembly;
securing a second end of the security line to the grain storage bin;
attaching the safety apparatus to a person or object to be rescued;
operating the safety apparatus to extract the person or object to be rescued; and
lowering the person or object safely to the ground.

18. The method of claim 17 further comprising securing a second security line to the pulley assembly.

19. The method of claim 18 further comprising installing a security line between the bottom frame and the grain storage bin.

20. The method of claim 18 further comprising providing a leg and adjusting the length of the leg.
